(19) United States
(12) Patent Application Publication
(10) Pub. No.: US 2024/0201912 A1
(43) Pub. Date: Jun. 20, 2024

(54) IMAGE FORMING APPARATUS AND DISPLAY CONTROL METHOD

(71) Applicant: SHARP KABUSHIKI KAISHA, Sakai City (JP)

(72) Inventor: CHIKARA MATSUDA, Sakai City (JP)

(21) Appl. No.: 18/530,636

(22) Filed: Dec. 6, 2023

(30) Foreign Application Priority Data
Dec. 16, 2022 (JP) 2022-201461

(51) Int. Cl. G06F 3/12

(52) U.S. Cl. CPC G06F 3/1219; G06F 3/1258

(57) ABSTRACT

An image forming apparatus includes: a display device that displays tray information on a paper feed tray attached to the apparatus; and one or more processors that control display on the display device. The tray information includes medium information on a stored recording medium. The one or more processors accept a switching instruction from a user, and switch a display form to one of a first display form, in which the tray information is displayed in a list, and a second display form, in which the medium information is displayed with a different information amount from that in the first display form.

### BACKGROUND OF THE INVENTION

### Field of the Invention

The present disclosure relates to an image forming apparatus and the like.

### Description of the Background Art

Some image forming apparatuses, such as a multifunction peripheral and a copier, can be attached with plural paper feed trays, each of which stores sheets or the like as recording media. Of these, there is an image forming apparatus of a console type capable of reducing time and effort of sheet replenishment and a frequency of printing interruption by adding, as an optional device, a paper feed tray capable of storing a large quantity of the sheets or a paper feed tray corresponding to storage of long sheets, for example, in addition to a configuration of a standard paper feed tray.

In the case where the image forming apparatus is configured to include the plural paper feed trays, it is required to identify the paper feed tray desired by a user from the plural paper feed trays such as the paper feed tray that stores sheets for image formation and the paper feed tray that has to be replenished with the sheets.

For example, the following image forming system and the like are disclosed in the related art. The image forming system displays a system configuration view and sheet information on the sheets on a screen that displays information on the paper feeder in a printing device, and thereby allows the user to check the paper feeder, for which storage of the sheets is completed. In the system configuration view, configurations of the paper feeders are displayed in a list, and the sheet information is set in association with each of the paper feeders.

The present disclosure relates to identification of a paper feed tray and has an object to provide an image forming apparatus and the like capable of easily grasping an attached state of the paper feed tray to the apparatus and sheets stored in each of the paper feed trays.

### SUMMARY OF THE INVENTION

In order to solve the above problem, an image forming apparatus according to the present disclosure includes: a display device that displays tray information on a paper feed tray attached to the apparatus; and one or more processors that control display on the display device. The tray information includes medium information on a stored recording medium. The one or more processors accept a switching instruction from a user, and switches a display form to one of a first display form, in which the tray information is displayed in a list, and a second display form, in which the medium information is displayed with a different information amount from that in the first display form.

In addition, a display control method according to the present disclosure is a display control method for controlling display of tray information on a paper feed tray that is attached to an apparatus. The tray information includes medium information on a stored recording medium. The display control method includes: accepting a switching instruction from a user; and switching a display form to one of a first display form, in which the tray information is displayed in a list, and a second display form, in which the medium information is displayed with a different information amount from that in the first display form.

The present disclosure can provide the image forming apparatus and the like capable of easily grasping an attached state of the paper feed tray to the apparatus and sheets stored in each of the paper feed trays.

### BRIEF DESCRIPTION OF THE DRAWINGS

FIG. 1 is a diagram illustrating a functional configuration of a multifunction peripheral according to a first embodiment.

FIG. 2A is a view illustrating a paper feed tray management table. FIG. 2B is a view illustrating a job management table.

FIG. 3 is a flowchart illustrating a processing flow according to the first embodiment.

FIG. 4 is a view illustrating an operation example according to the first embodiment.

FIG. 5 is a view illustrating the operation example according to the first embodiment.

FIG. 6 is a view illustrating the operation example according to the first embodiment.

FIG. 7 is a view illustrating the operation example according to the first embodiment.

FIG. 8 is a view illustrating the operation example according to the first embodiment.

FIG. 9 is a view illustrating the operation example according to the first embodiment.

FIG. 10 is a view illustrating the operation example according to the first embodiment.

FIG. 11 is a view illustrating the operation example according to the first embodiment.

FIG. 12 is a view illustrating the operation example according to the first embodiment.

FIG. 13 is a view illustrating the operation example according to the first embodiment.

FIG. 14 is a flowchart illustrating a processing flow according to a second embodiment.

FIG. 15 is a view illustrating an operation example according to the second embodiment.

FIG. 16 is a view illustrating a connection state between a multifunction peripheral according to a third embodiment and an external terminal apparatus.

FIG. 17 is a diagram illustrating a functional configuration of a multifunction peripheral according to the third embodiment.

FIG. 18 is a flowchart illustrating a processing flow according to the third embodiment.

FIG. 19 is a view illustrating an operation example according to the third embodiment.

FIG. 20A is a view illustrating the operation example according to the third embodiment.

FIG. 20B is a view illustrating the operation example according to the third embodiment.

FIG. 21A is a view illustrating another display form.

FIG. 21B is a view illustrating another display form.

### DESCRIPTION OF THE PREFERRED EMBODIMENTS

A description will hereinafter be made on embodiments of the present disclosure with reference to the drawings. The following embodiments are examples for illustrating the present disclosure, and the technical scope of the description in the claims is not limited to the following description.

When identifying a paper feed tray that is attached to an image forming apparatus, a user so far has referred to information on the paper feed tray via a display device or the like provided to the image forming apparatus (hereinafter may simply be referred to as tray information), or has directly and visually recognized articles stored in the paper feed tray, so as to identify the paper feed tray.

Since the display device provided to the image forming apparatus has limitations on a displayable area, a screen configuration, and the like, an amount of the tray information that can be displayed at a time is limited. Accordingly, when the number of the attached paper feed trays is increased, it is difficult to simultaneously provide a display form for comprehensively grasping attached states of the paper feed trays and a display form for thoroughly displaying sheet information (medium information such as a sheet name, a size, and basis weight) as the medium information on sheets stored in each of the paper feed trays.

The present disclosure relates to identification of the paper feed tray and provides the image forming apparatus capable of easily grasping the attached state of the paper feed tray to the apparatus and the sheets stored in each of the paper feed trays in the following embodiments.

### 1. First Embodiment

In a first embodiment, a description will be made on a multifunction peripheral as one form of the image forming apparatus. The multifunction peripheral can execute jobs in operation modes, such as printing, copying, faxing, and image transmission, in a single casing.

### 1.1 Functional Configuration

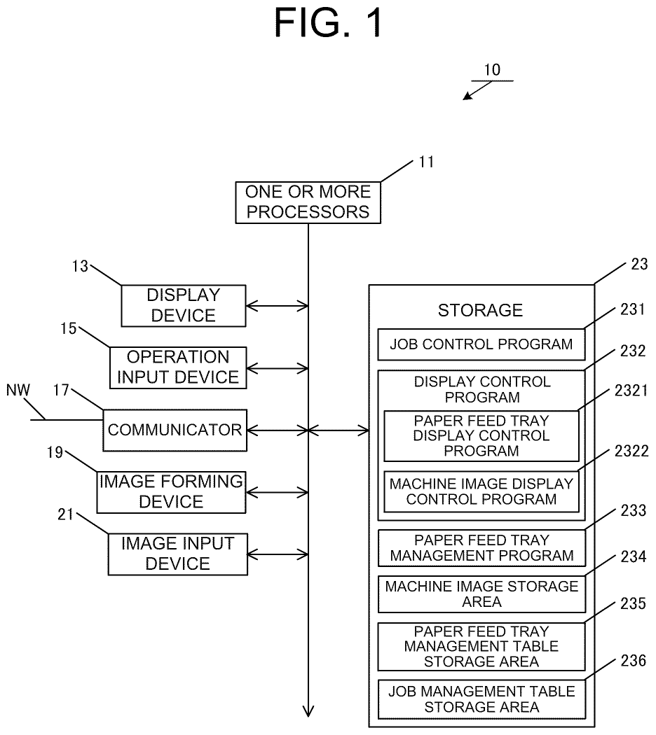

A description will be made on a functional configuration of a multifunction peripheral 10 according to the first embodiment. FIG. 1 is a functional configuration diagram of the multifunction peripheral 10. The multifunction peripheral 10 includes one or more processors 11, a display device 13, an operation input device 15, a communicator 17, an image forming device 19, an image input device 21, and a storage 23.

The one or more processors 11 control the overall multifunction peripheral 10. The one or more processors 11 include one or more arithmetic devices (such as one or more central processing units (CPUs)). The one or more processors 11 read and execute various programs stored in the storage 23 to implement functions thereof.

The display device 13 displays various types of information to a user or the like. The display device 13 can include, for example, a liquid-crystal display (LCD) or an organic electro-luminescence (EL) display, for example.

The operation input device 15 accepts input of the information by the user or the like. The operation input device 15 can include input units such as hard keys (for example, a numeric keypad) or buttons. Alternatively, the operation input device 15 can be configured as a touch panel that allows the input via the display device 13. In this case, as a touch panel input method, a general method such as a resistive film method, an infrared method, an electromagnetic induction method, or a capacitive sensing method can be used.

The communicator 17 includes any one or both of wired and wireless interfaces for communicating with another device via a network (NW) such as a local area network (LAN), a wide area network (WAN), the Internet, or a telephone line, or a fax line.

The image forming device 19 forms an image, which is based on image data, on a sheet or the like as a recording medium. The image forming device 19 feeds the sheet from the paper feed tray, forms the image, which is based on the image data, on the sheet, and thereafter discharges the sheet to a paper discharger. The image forming device 19 can include, for example, a laser printer using an electrophotographic method. In this case, the image forming device 19 forms the image by using toner supplied from toner cartridges, which are not illustrated. Each of the toner cartridges corresponds to a toner color (for example, cyan, magenta, yellow, or black).

The image input device 21 generates the image data by scanning a document. The image input device 21 includes an image sensor such as a charge coupled device (CCD) or a contact image sensor (CIS), and can be configured as a scanner device having an automatic document feeder (ADF), a flatbed, on which the document is placed and read, and the like. The configuration of the image input device 21 is not particularly limited as long as the image input device 21 is configured that the image data can be generated by reading a reflected light image from a document image with the image sensor. The image input device 21 can also be configured as an interface capable of acquiring the image data that is stored in a portable storage medium such as a universal serial bus (USB) flash drive and the image data transmitted from an external terminal apparatus (an information processor).

The storage 23 stores various programs necessary for operation of the multifunction peripheral 10, and various types of data. The storage 23 can include a storage device such as random access memory (RAM), a hard disk drive (HDD), a solid state drive (SSD), or read only memory (ROM).

In the first embodiment, the storage 23 stores a job control program 231, a display control program 232, and a paper feed tray management program 233, and secures a machine image storage area 234, a paper feed tray management table storage area 235, and a job management table storage area 236.

The job control program 231 is a program that is read by the one or more processors 11 to execute processing in each operation mode, such as a print mode, a copy mode, a fax mode, and an image transmission mode, on a job-by-job basis. The one or more processors 11 that have read the job control program 231 execute control for executing, holding, or stopping the job by controlling the display device 13, the operation input device 15, the communicator 17, the image forming device 19, the image input device 21, and the like. In addition, the one or more processors 11 that have read the job control program 231 manage the job to be executed by, for example, registering, deleting, or updating the job for a job management table, which will be described below.

The display control program 232 is a program that is read by the one or more processors 11 at the time of controlling a display screen displayed by the display device 13. The one or more processors 11 that have read the display control program 232 generate and display a system information screen and screen information on the display device 13. The system information screen includes: a home screen for accepting selection of the operation mode related to the job execution, and the like; a job setting screen, which is not illustrated, for accepting input of various setting values related to the job execution; and an information screen, which will be described below. The screen information includes: a machine image as a device configuration view simulating external appearance of the multifunction peripheral 10; and the like.

The display control program 232 includes a paper feed tray display control program 2321 and a machine image display control program 2322. The one or more processors 11 that have read the paper feed tray display control program 2321 controls display of the tray information. The one or more processors 11 that have read the machine image display control program 2322 execute control for generating and displaying the machine image on the display device 13. The machine image is generated by reflecting a machine state to the device configuration view simulating the external appearance of the multifunction peripheral 10.

The paper feed tray management program 233 is a program that is read by the one or more processors 11 at the time of generating the tray information, in which the sheet information is associated with the paper feed tray attached to the multifunction peripheral 10. The one or more processors 11 that have read the paper feed tray management program 233 manage the generated tray information in a paper feed tray management table, which will be described below. The one or more processors 11 that have read the paper feed tray management program 233 switch a display form of the tray information, which is set according to an operation status of the multifunction peripheral 10, from the currently displayed display form to the instructed display form on the basis of a switching instruction input by the user. In the present disclosure, the display form on the system information screen can be switched between a first display form and a second display form. In the first display form, all the paper feed trays that are attached to the multifunction peripheral 10 are displayed in a list. In the second display form, the sheet information is displayed with a different information amount from that in the first display form.

The machine image storage area 234 is a storage area where the one or more processors 11 that have read the machine image display control program 2322 store a machine image file displayed as the machine image on the display device 13.

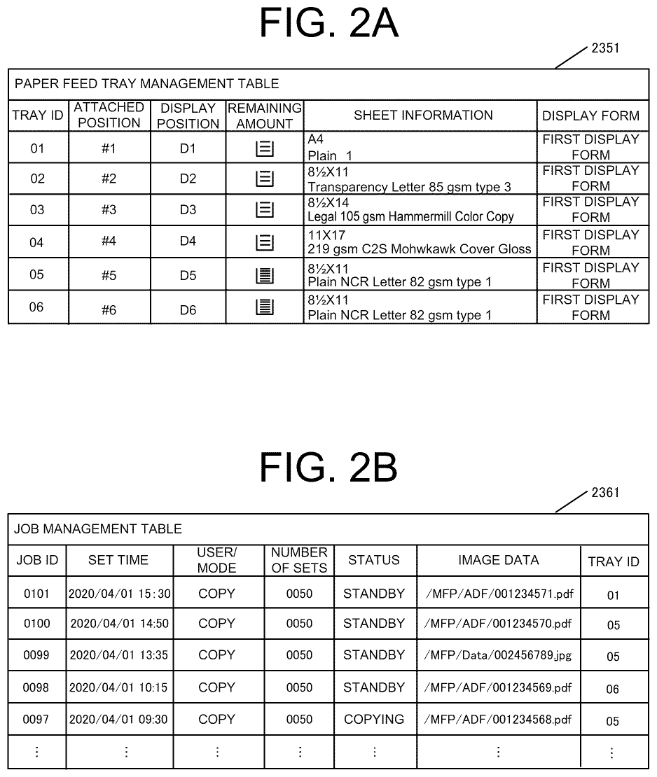

The paper feed tray management table storage area 235 is a storage area for storing the paper feed tray management table. A description will herein be made on the paper feed tray management table with reference to FIG. 2A. FIG. 2A is a view illustrating a configuration example of a data structure in the paper feed tray management table 2351.

The paper feed tray management table 2351 includes, as management items, a tray ID, an attached position, a display position, a remaining amount, the sheet information, and the display form. The tray ID is an identifier for uniquely identifying the paper feed tray. The attached position corresponds to an identifier for identifying an attachment port of the paper feed tray that is provided to the multifunction peripheral 10, and indicates an attached position of the paper feed tray to the multifunction peripheral 10. The display position indicates a display position of the paper feed tray on the system information screen. The remaining amount indicates a remaining amount of the sheets (the remaining number of the sheets) that are stored in the paper feed tray. The remaining amount of the sheets may be a detection result that is based on an optical or mechanical paper detection sensor, or may be an estimate value that is calculated on the basis of execution history of the jobs using the sheets stored in the paper feed tray, for example. In FIG. 2A, the remaining amount of the sheet is schematically exemplified by using an icon. However, a method for displaying the remaining amount of the sheets is not limited thereto. The remaining amount of the sheets may be expressed by a rate thereof to the total number of the sheets, which can be stored in the paper feed tray, in the form of a numerical value. The sheet information as the medium information indicates the sheet information on the sheets that are stored in the paper feed tray. The user may manually input the sheet information in association with the paper feed tray as a storage destination via a setting screen, which is not illustrated. Alternatively, the sheet information may be automatically downloadable from a server device or the like that can provide the sheet information. The display form indicates the set display form of the tray information. In the present disclosure, information in which the tray ID, the attached position, the display position, and the remaining amount are associated with the sheet information will be referred to as the tray information.

For example, the paper feed tray identified by a tray ID “01” indicates the paper feed tray that is attached at an attached position “#1” to the multifunction peripheral 10. Together with the remaining amount and the sheet information exemplified in FIG. 2A, the one or more processors 11 display the tray information on the paper feed tray with the tray ID “01” at a display position “D1” on the system information screen.

The job management table storage area 236 is a storage area where the one or more processors 11 that have read the job control program 231 store the job management table managed by the one or more processors 11. A description will herein be made on the job management table with reference to FIG. 2B. FIG. 2B is a view illustrating a configuration example of a data structure in a job management table 2361. FIG. 2B illustrates the job management table 2361 related to a copy job.

The job management table 2361 illustrated in FIG. 2B includes, as the management items, the job ID, set time, a user/mode, the number of sets, a status, the image data, and the tray ID. The job ID is an identifier for uniquely identifying the job that is registered as a job queue. The set time indicates time at which the job is set. In this case, the set time may be input time of a copy job execution instruction or may be time at which the document to be copied is set in the image input device 21 (for example, the scanner device or the like). The user/mode indicates a name of the user who executes the job, an operation mode name related to execution of the job, or the like. In the case where the name of the user who executes the job is unknown (for example, in the case where the execution user executes the job without logging into the multifunction peripheral 10, or the like), the item may be blank. The number of the sets indicates the number of copies to be made. The status indicates a job execution status such as standby, copying, or the like. The image data indicates a storage destination (a folder/file path) of the image data as the original image to be copied. The tray ID indicates the tray ID of the paper feed tray that stores the sheets to be used in the copy job.

For example, a job that is identified by a job ID “0101” represents a job that is related to an operation mode “COPY” and is set at set time “2020/04/01 15:30”. The copy job is an example in which image date “MFP/ADF/001234571.pdf” is set as the original image to be copied and in which “0050” copies is set as the number of the sets. The status of the copy job is “standby”. The tray IDs managed by the job management table 2361 and the tray IDs managed by the paper feed tray management table 2351 have the same values. That is, by referring to the job management table 2361, the one or more processors 11 can grasp the paper feed tray that stores the sheets used for the execution of the job.

### 1.2 Processing Flow

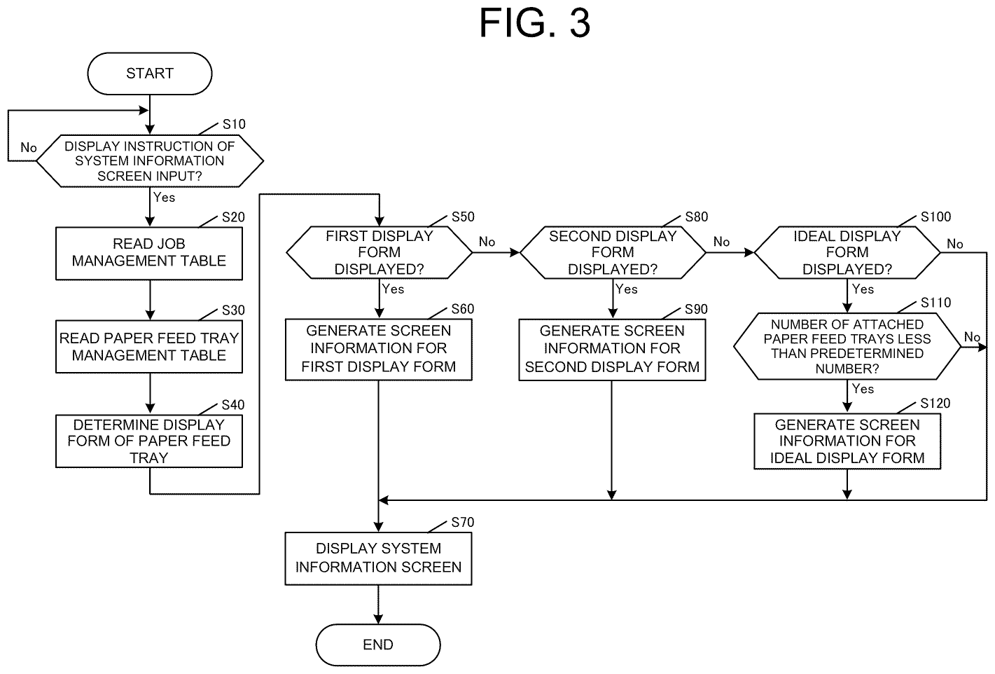

Next, a description will be made on a processing flow in the first embodiment. The processing is illustrated in FIG. 3 as a flowchart of display control that is executed when the display form of the tray information is set in advance via the setting screen, which will be described below. The processing illustrated in FIG. 3 is processing that is executed when the one or more processors 11 mainly read the display control program 232, the paper feed tray management program 233, and the like.

First, the one or more processors 11 determine whether an instruction to display the system information screen, which includes a tray information display area, has been input (step S10). If determining that the instruction to display the system information screen has been input, the one or more processors 11 read the job management table 2361, which has been described with reference to FIG. 2B (step S10; Yes→step S20). At this time, in addition to the values of the management items acquired by reading the job management table 2361, the one or more processors 11 may acquire a remaining amount of a developer such as the toner, network information such as an IP address, and another machine information necessary for the configuration of the system information screen, for example. On the other hand, if determining that the instruction to display the system information screen has not been input, the one or more processors 11 wait until the display instruction is input (step S10; No).

Next, the one or more processors 11 read the paper feed tray management table 2351 (step S30). The one or more processors 11 refer to the value of the display form that is one of the management items in the read paper feed tray management table 2351, and determine the display form of the tray information (step S40).

As a result of the reference to the paper feed tray management table 2351, if determining that the display form of the tray information, which is set in advance, is “FIRST DISPLAY FORM”, the one or more processors 11 generate the screen information for the first display form (step S50; Yes→step S60). Then, the one or more processors 11 display the system information screen on the basis of the generated screen information for the first display form, and terminate the processing (step S70).

On the other hand, if determining that the display form of the tray information, which is set in advance, is not “FIRST DISPLAY FORM”, the one or more processors 11 determine whether the display form of the tray information, which is set in advance, is “SECOND DISPLAY FORM” (step S50; No→step S80).

If determining that the display form of the tray information, which is set in advance, is “SECOND DISPLAY FORM”, the one or more processors 11 generate the screen information for the second display form (step S80; Yes→step S90). Then, the one or more processors 11 display the system information screen on the basis of the generated screen information for the second display form, and terminate the processing (step S70).

On the other hand, if determining that the display form of the tray information, which is set in advance, is not “SECOND DISPLAY FORM, the one or more processors 11 determine whether the display form of the tray information, which is set in advance, is “IDEAL DISPLAY FORM” (step S80; Yes→step S100).

Here, the ideal display form means a display form that has characteristics of both the first display form and the second display form. That is, the ideal display form is a display form that has both of a list display property and a detail display property. The list display property is a property to display the tray information on all the paper feed trays attached to the multifunction peripheral 10 in a list. The detail display property is a property to display details of the sheet information on the sheets stored in each of the paper feed trays. In the case where the tray information is displayed on the basis of the ideal display form, the display area related to the first display form is enlarged to secure the display area for the details of the sheet information. For this reason, pieces of the tray information (the number of the paper feed trays) that can be displayed at a time are reduced when compared to those in the first display form. Thus, in the present disclosure, when the ideal display form is specified as the display form, processing is provided to determine the number of the paper feed trays that are attached to the multifunction peripheral 10.

If determining in step S100 that the display form of the tray information is “IDEAL DISPLAY FORM”, the one or more processors 11 determine whether the number of the paper feed trays that are attached to the multifunction peripheral 10 is less than a predetermined number (step S100; Yes→step S110). If determining that the number of the paper feed trays that are attached to the multifunction peripheral 10 is less than the predetermined number, the one or more processors 11 generate the screen information for the ideal display form (step S110; Yes→step S120). Then, the one or more processors 11 display the system information screen on the basis of the generated screen information for the ideal display form, and terminate the processing (step S70).

If the ideal display form is not specified as the display form of the tray information (step S100; No), and if the one or more processors 11 determine that the number of the paper feed trays that are attached to the multifunction peripheral 10 is equal to or more than the predetermined number (step S110; No), the one or more processors 11 do not execute the display control of the tray information, and the processing proceeds to the system information screen display processing in step S70.

### 1.3 Operation Example

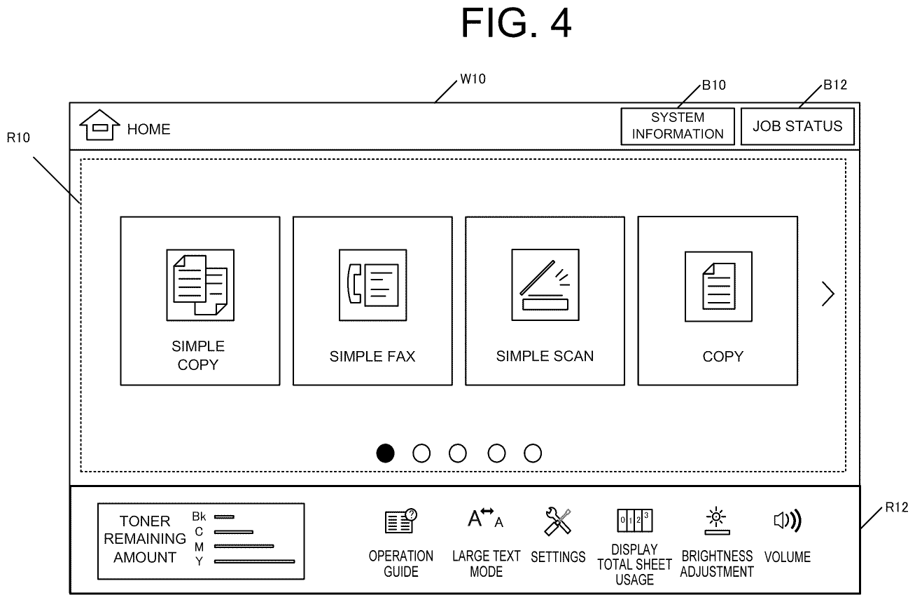

Next, a description will be made on an operation example according to the first embodiment. FIG. 4 is a view illustrating a display configuration example of a home screen W10 for accepting the instruction to display the system information screen. The home screen W10 exemplified in FIG. 4 can be configured as a basic screen that is displayed on the display device 13, for example, at power-on, during the standby, at the time of returning from a sleep state, or the like, and accepts the operation input by the user. The home screen W10 includes a mode selection button display area R10, a fixed display area R12, a system information button B10, and a job status button B12.

The mode selection button display area R10 is a display area that displays a mode selection button, a functional selection button, and the like. The mode selection button accepts an instruction to select the operation mode for the job execution. The function selection button accepts a display instruction and the like of an address book, in which destination information and the like for the image transmission job are managed, and setting history information in which history of the executed jobs is associated with the setting values for the respective jobs. The home screen W10 illustrated in FIG. 4 is an example in which the mode selection buttons for the operation modes, “SIMPLE COPY”, “SIMPLE FAX”, “SIMPLE SCAN”, and “COPY”, are displayed. By selecting any of the mode selection buttons displayed in the mode selection button display area R10, the user can execute the job in the operation mode that corresponds to the mode selection button. The configuration example of the mode selection buttons and the like illustrated in FIG. 4 is merely an example, and the settings can be changed via the setting screen, which is not illustrated.

The fixed display area R12 is an area where machine setting items related to a language setting, an operation guide, maintenance, and the like are displayed, and is a display area whose display position is fixed. FIG. 4 illustrates an example in which, as the machine setting items, “TONER REMAINING AMOUNT”, “OPERATION GUIDE”, “LARGE TEXT MODE”, “SETTINGS”, “DISPLAY TOTAL SHEET USAGE”, “BRIGHTNESS ADJUSTMENT”, AND “VOLUME” are displayed. The display position of the fixed display area R12 is not fixed to the position illustrated in FIG. 4 (under the mode selection button display area R10). The display position of the fixed display area R12 can also be set above the mode selection button display area R10 or at right or left end of the home screen W10.

The system information button B10 is a button for accepting the input of the instruction to display the system information screen as the information screen, which will be described with reference to the subsequent drawings and the like. When the system information button B10 is selected and the input of the instruction to display the system information screen is accepted, the one or more processors 11 display the system information screen.

The job status button B12 is a button for accepting the selection of the instruction to display a job execution screen, to which the job execution status is reflected. When the job status button B12 is selected and the input of the instruction to display the job execution screen is accepted, the one or more processors 11 display the job execution screen, which is not illustrated.

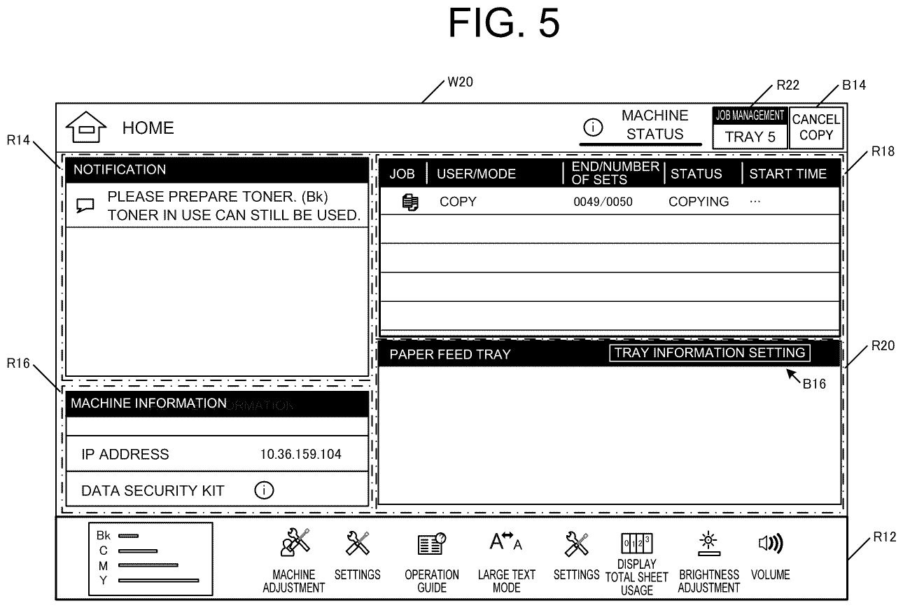

Next, a description will be made on the system information screen that is displayed by the one or more processors 11 when the one or more processors 11 accept the user's selection of the system information button B10 on the home screen W10 with reference to FIG. 5. A system information screen W20 illustrated in FIG. 5 is a screen that collectively displays a notification to the user, machine information of the multifunction peripheral 10, and information on the job execution status, the tray information, the machine setting items, and the like.

The system information screen W20 exemplified in FIG. 5 includes a notification area R14, a machine information area R16, a job queue area R18, a tray information area R20, and the fixed display area R12. Since the fixed display area R12 can have the same configuration as the fixed display area R12 that is provided in the home screen W10 illustrated in FIG. 4, a description thereon will not be made.

The notification area R14 is a display area where a notification content to the user is displayed as the notification. The machine information area R16 is a display area where information unique to the multifunction peripheral 10 is displayed as the machine information. Examples of the unique information are network setting information such as the IP address and option information applied to the multifunction peripheral 10.

The job queue area R18 is a display area where information on the job execution status and information on the reserved job (the job queue) are displayed. The one or more processors 11 display the screen information, to which the contents of the management items read from the job management table 2361 (step S20 in FIG. 3) are reflected, in the job queue area R18.

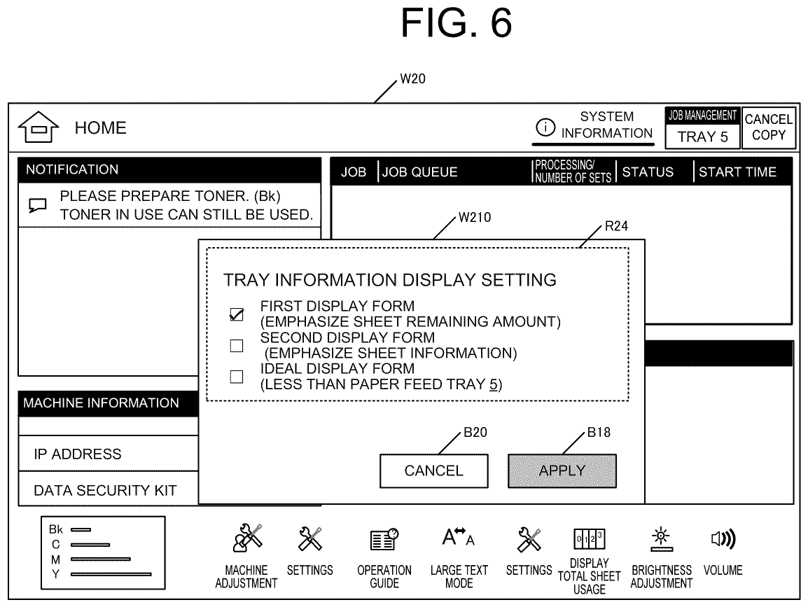

The tray information area R20 is a display area where the tray information that corresponds to the first display form, the second display form, or the ideal display form is displayed. A tray information setting button B16 provided in the tray information area R20 is a button for accepting input of the instruction to display a tray information display setting screen W210, which will be described with reference to FIG. 6. A display configuration example of the tray information area R20 will be described below.

A job management information area R22 is a display area where any of the management items that are selected from the job management table 2361 is displayed in relation to the job execution. FIG. 5 illustrates an example of the job management information area R22 that is set to display the tray information for the currently executed job as the management item displayed therein. For example, in the case where the paper feed tray that stores the sheets used in the copy job is the paper feed tray 5 (the tray ID “05”), “TRAY 5” is displayed as the currently used paper feed tray in the job management information area R22. The user can grasp the paper feed tray currently used in the copy job or the print job by checking the paper feed tray displayed in the job management information area R22.

A copy cancel button B14 is a button for accepting an instruction to cancel copying that is currently executed. In some cases, the display of the copy cancel button B14 is switched to display of a FAX cancel button, an image transmission cancel button, or the like, for example, according to the currently executed operation mode.

FIG. 6 is a view illustrating a display configuration example of the tray information display setting screen W210 for accepting a tray information display setting. The one or more processors 11 display the tray information display setting screen W210, for example, by accepting selection of the tray information setting button B16 provided in the tray information area R20.

The tray information display setting screen W210 includes a tray information display setting area R24, an apply button B18, and a cancel button B20. The tray information display setting area R24 is an area where an instruction to select the display form of the tray information is accepted. The tray information display setting area R24 includes a first display form selection check box, a second display form selection check box, and an ideal display form selection check box.

The first display form selection check box is a check box for accepting the instruction to display all the paper feed trays attached to the multifunction peripheral 10 in the list. Such display is in the display form that emphasizes the list display property of the remaining amounts of the sheets in all the paper feed trays.

The second display form selection check box is a check box for selecting the display form that emphasizes the detail display property of the sheet information on each of the paper feed trays and for accepting the instruction to display the larger amount of the tray information per the paper feed tray than the amount of the tray information in the first display form.

The ideal display form selection check box is a check box for accepting the instruction to display the display form that has both of the list display property and the detail display property. The list display property is the property to display the list of the tray information on all the paper feed trays attached to the multifunction peripheral 10. The detail display property is the property to display the details of the sheet information on the sheets stored in each of the paper feed trays. As exemplified in FIG. 6, the ideal display form selection check box can also accept input of a threshold of the number of the attached paper feed trays that can be displayed in the ideal display.

The apply button B18 is a button for accepting an instruction to apply the display form of the tray information. When the user specifies the desired display form and selects the apply button B18, the one or more processors 11 register the specified display form in the management item of the display form in the paper feed tray management table 2351 exemplified in FIG. 2A. The cancel button B20 is a button for accepting an instruction to cancel the tray information display setting.

By the way, the display form that is set via the tray information display setting screen W210 can be managed by creating a profile per user (login user) of the multifunction peripheral 10. In this case, it is also possible to adopt a configuration that the display form is switched among the first display form, the second display form, and the ideal display form per login user by applying the profile that corresponds to the user who has logged into the multifunction peripheral 10.

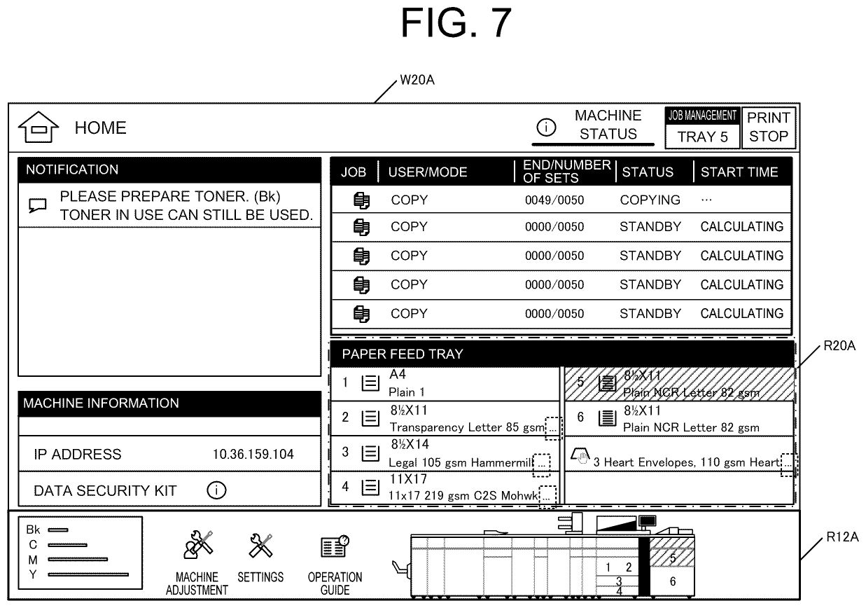

Next, FIG. 7 is a view illustrating a display configuration example of a system information screen W20A when the first display form is selected as the display form of the tray information. A tray information area R20A in the system information screen W20A in the first display form is an example in which the tray information on a manual feed tray and the paper feed trays 1 to 6 is displayed in a list, and corresponds to the tray information that is managed in the paper feed tray management table 2351 exemplified in FIG. 2B.

In the tray information area R20A, the tray information from the paper feed tray 1 to the paper feed tray 4 is displayed from an upper left side to a lower left side of the area, and the tray information on the paper feed trays 5, 6 and the manual feed tray is displayed from an upper right side to a lower right side of the area. In the tray information area R20A, a display area for each piece of the tray information is set such that a total of eight pieces of the tray information can be displayed. In addition, in regard to the sheet information that cannot be displayed in the display area, an elision symbol “ . . . ” in a dotted line frame in FIG. 7 is displayed, so as to indicate presence of the sheet (medium) information, the display of which is omitted.

For example, in the display area for the paper feed tray 2, “8½X11 Transparency Letter 85 gsm . . . ” of the sheet information “8½X11 Transparency Letter 85 gsm type 3” (see FIG. 2A) is displayed in addition to an icon representing the remaining amount of the sheets. The display of “type 3” that cannot be provided in the display area is omitted and replaced with the display of the elision symbol “ . . . ”. Similarly, the sheet information on the paper feed trays 3, 4 and the manual feed tray is partially omitted.

Furthermore, in the tray information area R20A, the display area for the tray information, which corresponds to the paper feed tray currently used for the executed job (the copy job), can be displayed in a different display mode from the display area for the tray information on the other paper feed trays. For example, FIG. 7 illustrates a mode in which the display area for the tray information corresponding to the paper feed tray 5, as the currently used paper feed tray, is filled with a diagonal line pattern. However, a display color, a filling pattern, or the like is not limited as long as the display mode enables identification of the paper feed tray (the tray information), from which the sheets are fed. A configuration position of the paper feed tray to be clearly indicated may be expressed by blinking of the tray information or by using a different text font, a different text size, or the like. Alternatively, audio guidance can be provided to guide to such a position.

In addition to the clear indication of the paper feed tray in the tray information area R20A, the one or more processors 11 display the machine image, which simulates the external appearance of the multifunction peripheral 10, in a fixed display area R12A. In the machine image displayed in the fixed display area R12A, the attached position of the paper feed tray, which corresponds to the paper feed tray clearly indicated in the tray information area R20A, is highlighted. Similar to the display mode of the paper feed tray in the tray information area R20A, the display mode, such as the display color or the filling pattern, is not particularly limited as long as the paper feed tray, from which the sheets are fed, can be identified in the overall configuration of the machine. Just as described, when the job (the copy job) is executed, the portion corresponding to the paper feed tray as a sheet feeding source is highlighted in the machine image. Accordingly, the user can easily grasp the paper feed tray as a sheet supply source. Here, the highlighted display of the paper feed tray in the tray information area R20A and the highlighted display in the machine image are desirably in the same display mode.

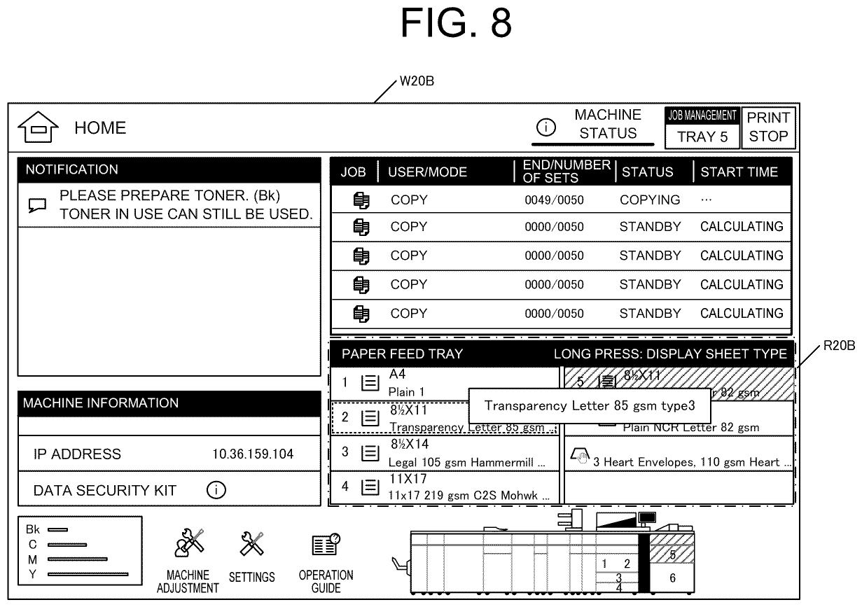

FIG. 8 is a view illustrating a form in which a tooltip is provided as a display element in order to display the sheet information, which cannot be displayed in the display area, in the first display form. Here, the tooltip is a display element for displaying the omitted information (the sheet paper in the present embodiment) as an annotation or supplementary information in a small peripheral display area. For example, the user can display the omitted sheet information via the display area in a balloon shape, a rectangular shape, or the like, for example, by tapping, double-tapping, flicking, swiping, scrolling, dragging, touching, or long-pressing (the display area for) the tray information. In this case, a display position may be above a position pressed (operated) by the user's finger, may partially or completely overlap the tray information to be displayed, or may be a position that does not overlap the tray information to be displayed at all. In addition, a background color, a display font, a size, and the like of the tooltip display area can be in a different mode from a background color, a display font, a size, and the like of the tray information display area. Furthermore, the display area for the tooltip can be deleted from the display screen after a predetermined time elapses or after the user's finger separates from the display screen.

For example, FIG. 8 illustrates an example of a system information screen W20B in which the sheet information as the tooltip for displaying the omitted sheet information is displayed in the rectangular display area. When the one or more processors 11 accept long pressing of the tray information on the paper feed tray 2 (a dotted line frame in FIG. 8) by the user, the one or more processors 11 display the sheet information “Transparency Letter 85 gsm type 3” on the paper feed tray 2 in the rectangular display area in the tray information area R20B.

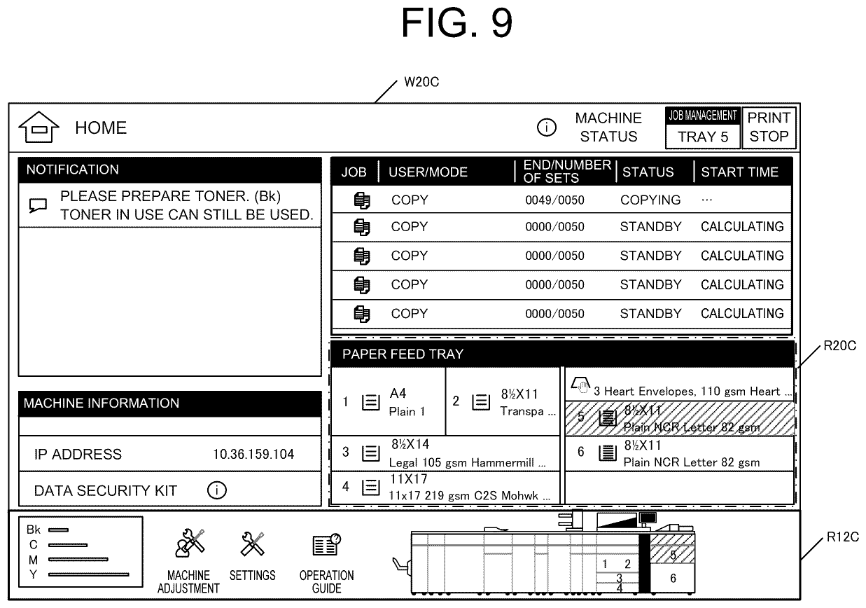

Next, FIG. 9 is a view illustrating a display configuration example of the tray information, to which the attached states of the paper feed trays to the multifunction peripheral 10 are reflected, in the first display form. For example, as illustrated in the fixed display area R12C, in the case where the paper feed trays 1, 2 are attached side by side to the multifunction peripheral 10, pieces of the tray information corresponding to the paper feed trays 1, 2 are arranged side by side and displayed in a tray information area R20C on a system information screen W20C. With such a configuration, the user can easily image the actual attached states of the paper feed trays that are attached to the multifunction peripheral 10.

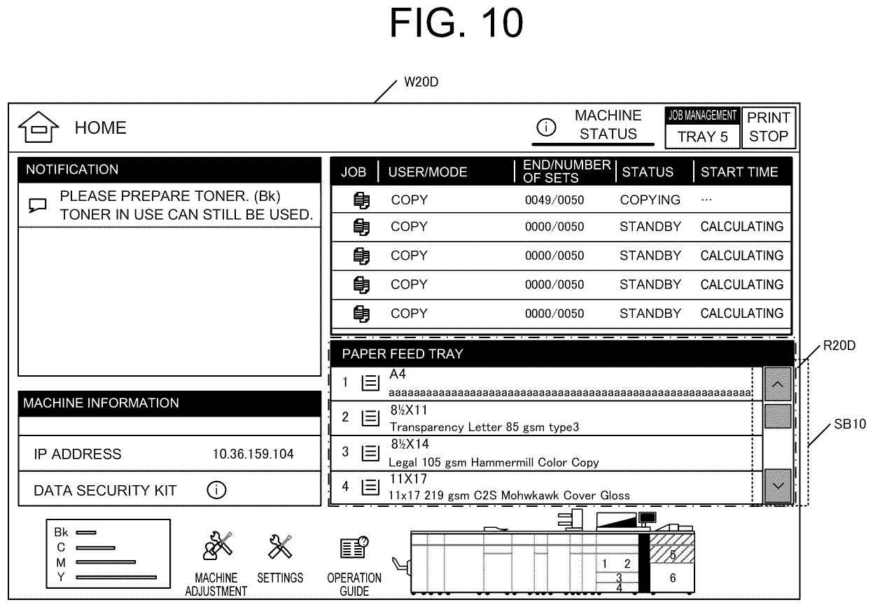

Next, FIG. 10 is a view illustrating a display configuration example of a system information screen W20D when the second display form is selected as the display form of the tray information. A tray information area R20D in the second display form has a display area where the larger amount of the information can be displayed than the display area for the individual tray information in the tray information area R20A. FIG. 10 illustrates an example in which a display area corresponding to the two tray information display areas in two columns of the tray information area R20A is allocated to each piece of the tray information. In the second display form, even the sheet information, which has the large amount of the information to be displayed, in the tray information (for example, the paper feed tray 1: the sheet information “A4 aaaa . . . ”) can be displayed completely.

Since the second display form is the display form that prioritizes the display of the sheet information, the number of the displayable pieces of the tray information on a single display screen in the tray information area R20D is limited. For this reason, in the second display form, a widget that accepts a screen moving operation is provided to indicate the presence of the tray information that is not displayed.

Here, the widget is a display/operation element to move the display area on the single display screen in order to display the tray information that does not fit in the display screen. FIG. 10 illustrates an example in which a scroll bar SB10 is provided as the widget at a right end of the tray information area R20D. The user can display the tray information that is not displayed by operating upper/lower arrows and a knob of the scroll bar SB10. Instead of the scroll bar for moving the display area, for example, a pull-down menu can be used to display the hidden tray information on a right, left, or lower side of the tray information area R20D by a touch or tap operation at a suitable position in the tray information area R20D. Furthermore, instead of the widget such as the scroll bar, the second display form can be configured that the display area in the tray information area R20D can be moved by a swipe or flick operation on the screen.

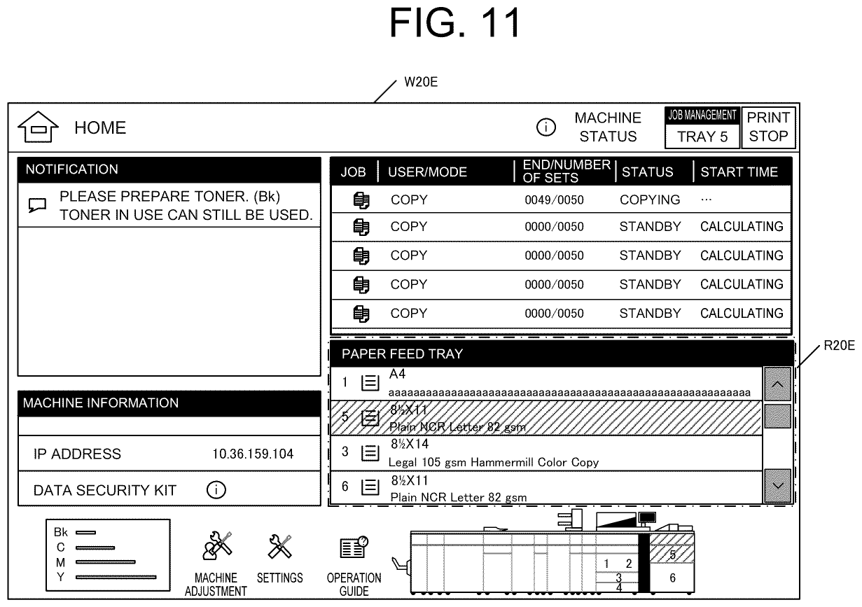

Next, FIG. 11 is a view illustrating a display configuration example of a system information screen W20E, on which a display order of the tray information is determined and displayed according to a use frequency of each of the paper feed trays, in the second display form. FIG. 11 illustrates an example in which, when the paper feed tray 5 is second in use frequency rankings for the job execution among all the paper feed trays, for example, the tray information on the paper feed tray 5 is displayed by following the tray information on the paper feed tray 1, which is first in the use frequency rankings, in a tray information area R20E.

The use frequency rankings of the paper feed trays may manually be set by the user via an unillustrated setting screen. Alternatively, a program or the like may be used to implement a determination unit that determines the rankings on the basis of the use frequency acquired from a count value of the number of uses of each of the paper feed trays. The one or more processors 11 determine the display order of the tray information that is displayed in the tray information area R20E according to the settings by the user or the use frequency rankings of the paper feed trays that are determined by the determination unit. With such a configuration, the user can grasp the tray information (the sheet remaining amount, the sheet information, and the like) on the frequently used paper feed tray without scrolling the display, or the like, and thus can predict sheet replenishment timing.

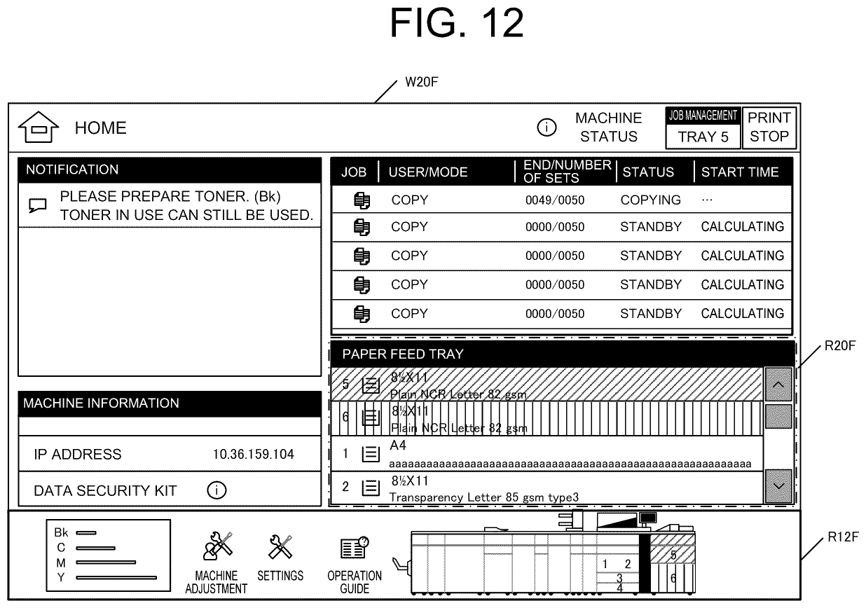

Next, FIG. 12 is a view illustrating a display configuration example of a system information screen W20F in which, in the second display form, the tray information on the paper feed tray, which is currently used in the executed job, and the tray information on the paper feed tray, which is scheduled to be used in the next job, are displayed in a different display form from the display form of the tray information on the other unused paper feed trays. FIG. 12 illustrates an example in which, in the case where the paper feed tray, which is currently used (operated) in the executed job is the paper feed tray 5 (indicated by the diagonal line pattern in FIG. 12), and the paper feed tray, which is scheduled to be used in the next job, is the paper feed tray 6 (indicated by a vertical line pattern in FIG. 12), the tray information on such paper feed trays is highlighted in a tray information area R20F. However, the display color, the filling pattern, or the like is not limited as long as the display mode enables the identification of the paper feed tray, which is currently used or is scheduled to be used. The configuration position of the paper feed tray to be clearly indicated may be expressed by blinking of the tray information or by using the different text font, the different text size, or the like. Alternatively, the audio guidance can be provided to guide to such a position.

At this time, the attached position of the paper feed tray, which corresponds to the paper feed tray clearly indicated in the tray information area R20F, may be highlighted in the machine image displayed in a fixed display area R12F. Similar to the display mode of the tray information in the tray information area R20F, the display mode, such as the display color or the filling pattern, is not particularly limited as long as the paper feed tray, from which the sheets are fed, can be identified in the overall configuration of the machine. Here, the highlighted display of the paper feed tray in the tray information area R20F and the highlighted display thereof in the machine image are desirably in the same display mode.

Just as described, when the tray information on the paper feed tray, which is currently used in the executed job, and the tray information on the paper feed tray, which is scheduled to be used in the next job, are displayed in the different display form from the display form of the tray information on the other unused paper feed trays, the user can grasp the paper feed tray, which is currently used or is scheduled to be used. As a result, since the sheet replenishment or the maintenance of the paper feed tray, which is not scheduled to be used, can preferentially be performed, for example, it is possible to avoid a disadvantage such as lowered productivity due to printing interruption caused by the sheet replenishment or the maintenance of the paper feed tray, which is currently used or is scheduled to be used.

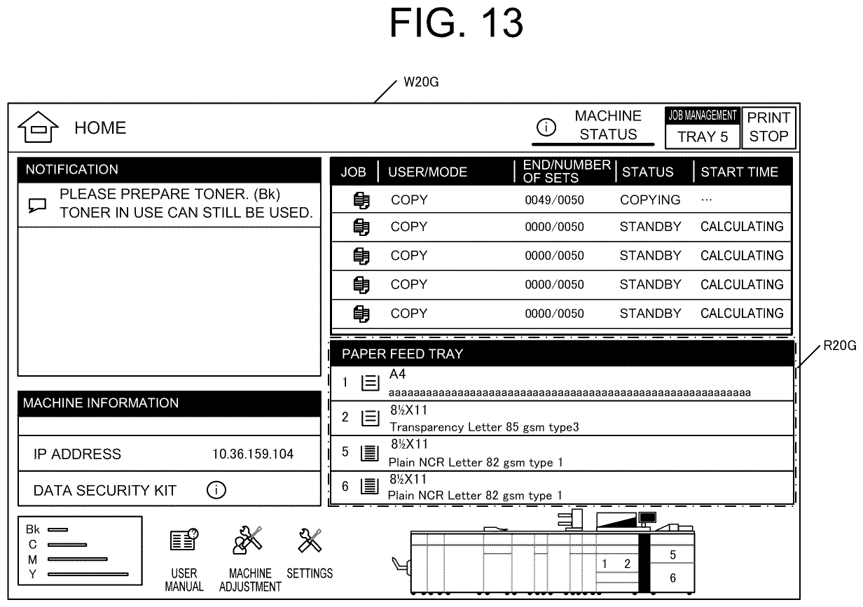

Next, FIG. 13 is a view illustrating a display configuration example of a system information screen W20G when the ideal display form is selected as the display form of the tray information. The ideal display form is the display form that has both of the list display property and the detail display property. The list display property is the property to display the tray information on all the paper feed trays attached to the multifunction peripheral 10 in the list. The detail display property is the property to display the details of the sheet information on the sheets stored in each of the paper feed trays.

In the case where the ideal display form is selected as the display form of the tray information, and the number of the pieces of the tray information to be displayed is less than a predetermined display number, the one or more processors 11 execute control to expand the display area and increase the amount of the displayed sheet information. FIG. 13 is a display example of a tray information area R20G in the case where the threshold of the number of the attached paper feed trays that can be displayed in the ideal display form is less than five. As exemplified in FIG. 13, in the case where the number of the pieces of the tray information to be displayed is less than five (the four paper feed trays 1, 2, 5, 6 in FIG. 13), the one or more processors 11 expand the display area to display the sheet information on the paper feed trays 1, 2, 5, 6, thereby increase the amount of the displayed sheet information, and implement both of the list display property of the tray information and the detail display property of the tray information.

As it has been described so far, according to the first embodiment, it is possible to switch the display between the first display form excellent in the list display property and the second display form excellent in the detail display property according to the operation status by the user. For example, in the operation in which the tray information is not frequently changed (a use form in which a replacement frequency of the sheets is relatively low), the first display form is selected. In this way, it is possible to intuitively grasp the remaining amount of the sheets in each of the paper feed trays. Meanwhile, in the operation in which the tray information is frequently changed (a use form in which the replacement frequency of the sheets is relatively high), the second display form is selected. In this way, it is possible to thoroughly grasp the information on the sheets that are stored in each of the paper feed trays.

### 2. Second Embodiment

The first embodiment is the embodiment in which the tray information is displayed in any one of the first display form, the second display form, and the ideal display form on the basis of the setting content that is set in advance via the tray information display setting screen W210 in FIG. 6. A second embodiment is an embodiment in which the instruction to switch the display form of the tray information is accepted while the system information screen is displayed (while the tray information is displayed in any one of the display forms).

### 2.1 Functional Configuration

Since a multifunction peripheral according to the second embodiment can have the same functional configuration as the multifunction peripheral 10 according to the first embodiment, components thereof will be denoted by the same reference numerals, and a description thereon will not be made.

### 2.2 Processing Flow

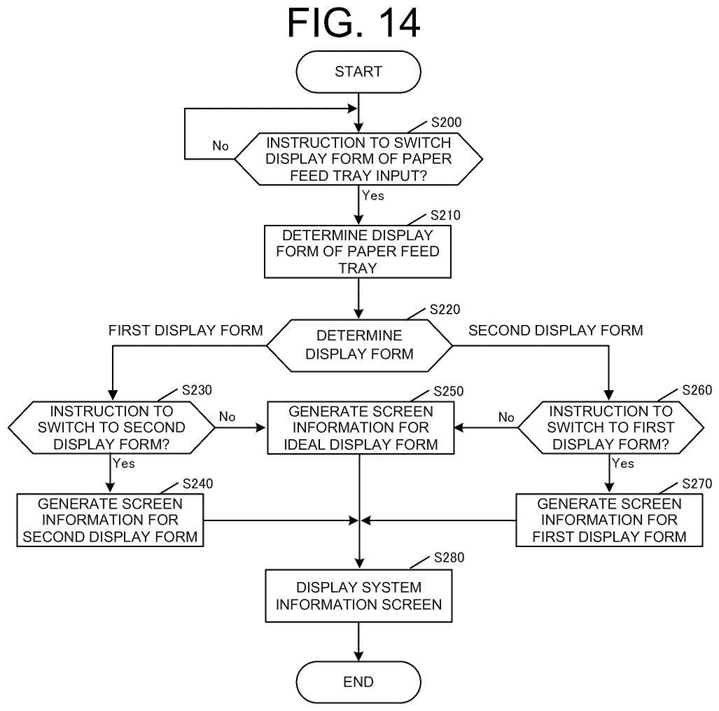

FIG. 14 is a flowchart illustrating the display control in the case where the input of the instruction to switch the display form related to the display of the tray information is accepted while the tray information is displayed. Processing illustrated in FIG. 14 is processing that is executed when the one or more processors 11 mainly read the display control program 232, the paper feed tray management program 233, and the like. The description on FIG. 14 will be initiated from a state where the tray information is displayed in any one of the display forms.

The one or more processors 11 determine whether the instruction to switch the display form of the tray information has been accepted via the system information screen, for example (step S200). If determining that the instruction to switch the display form of the tray information has been accepted, the one or more processors 11 determine the display form of the tray information that is currently displayed (step S200; Yes→step S210). The determination processing of the display form of the tray information can be executed in the same manner as the determination processing of the display form in step S40 illustrated in FIG. 3. On the other hand, if determining that the instruction to switch the display form of the tray information has not been accepted, the one or more processors 11 wait until the switching instruction is input (step S200; No).

If determining that the display form of the tray information, which is currently displayed, is the first display form, the one or more processors 11 determine whether the accepted switching instruction is the instruction to switch the display form to the second display form (step S220; “FIRST DISPLAY FORM”→step S230). If determining that the accepted switching instruction is the instruction to switch the display form to the second display form, the one or more processors 11 generate the screen information for the second display form (step S230; Yes→step S240). Then, the one or more processors 11 display the system information screen on the basis of the generated screen information for the second display form, and terminate the processing (step S280).

If determining that the accepted switching instruction is not the instruction to switch the display form to the second display form, the one or more processors 11 generate the screen information for the ideal display form (step S230; No→step S250). Then, the one or more processors 11 display the system information screen on the basis of the generated screen information for the ideal display form, and terminate the processing (step S280).

By the way, if determining that the display form of the tray information, which is currently displayed, is the second display form, the one or more processors 11 determine whether the accepted switching instruction is the instruction to switch the display form to the first display form (step S220; “SECOND DISPLAY FORM”→step S260). If determining that the accepted switching instruction is the instruction to switch the display form to the first display form, the one or more processors 11 generate the screen information for the first display form (step S260; Yes→step S270). Then, the one or more processors 11 display the system information screen on the basis of the generated screen information for the first display form, and terminate the processing (step S280).

On the other hand, if determining that the accepted switching instruction is not the instruction to switch the display form to the first display form, the one or more processors 11 generate the screen information for the ideal display form (step S260; No→step S250). Then, the one or more processors 11 display the system information screen on the basis of the generated screen information for the ideal display form, and terminate the processing (step S280).

Before the screen information for the ideal display form is generated in step S250, similar to step S110 in FIG. 3, determination processing may be provided to determine the number of the paper feed trays that are attached to the multifunction peripheral 10. In addition, when the user does not desire the display in the ideal display form, the processing to generate the screen information for the ideal display form in step S250 may be omitted.

### 2.3 Operation Example

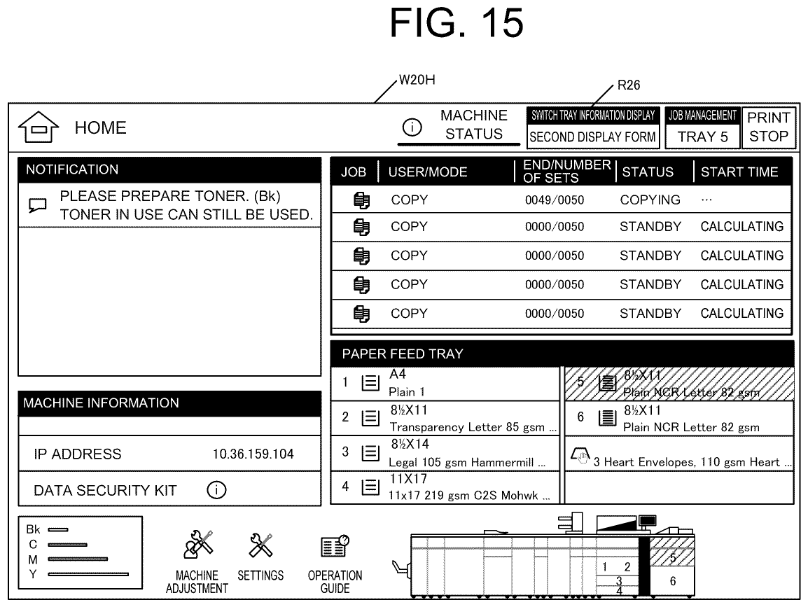

Next, a description will be made on an operation example according to the second embodiment. FIG. 15 illustrates a display configuration example of a system information screen W20H according to the second embodiment. The system information screen W20H can have the same configuration as the system information screen W20A, which has been described with reference to FIG. 7 and the like, except for a configuration of a tray information display switching area R26.

The tray information display switching area R26 is a display area for displaying the switchable display form (for example, the second display form), and can be configured as a selection button for accepting the display switching instruction by the user. For example, when the user selects the tray information display switching area R26 exemplified in FIG. 15, the one or more processors 11 execute control to switch the display form of the tray information from the first display form to the second display form.

As it has been described so far, according to the second embodiment, the display form of the tray information can be switched while the system information screen is displayed (while the tray information is displayed in any one of the display form). Thus, the user can acquire the tray information at necessary timing and according to a purpose.

### 3. Third Embodiment

A third embodiment is an embodiment in which the screen information on the system information screen, which includes the tray information area described in the first and second embodiments, can be output to the external terminal apparatus.

### 3.1 Functional Configuration

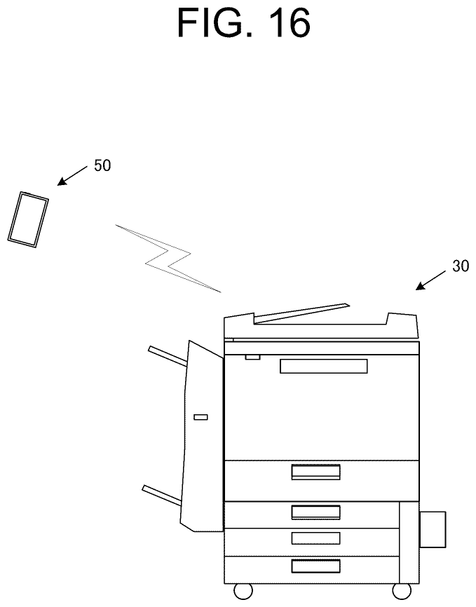

FIG. 16 is a view illustrating an example of a connection form between a multifunction peripheral 30 according to the third embodiment and an external terminal apparatus 50. The external terminal apparatus 50 is communicably connected to the multifunction peripheral 30 via a short-range wireless communication protocol such as Wi-Fi®, Bluetooth®, infrared rays, near field communication (NFC), or radio frequency identification (RFID). The external terminal apparatus 50 is configured to be able to acquire the screen information on the system information screen from the multifunction peripheral 30.

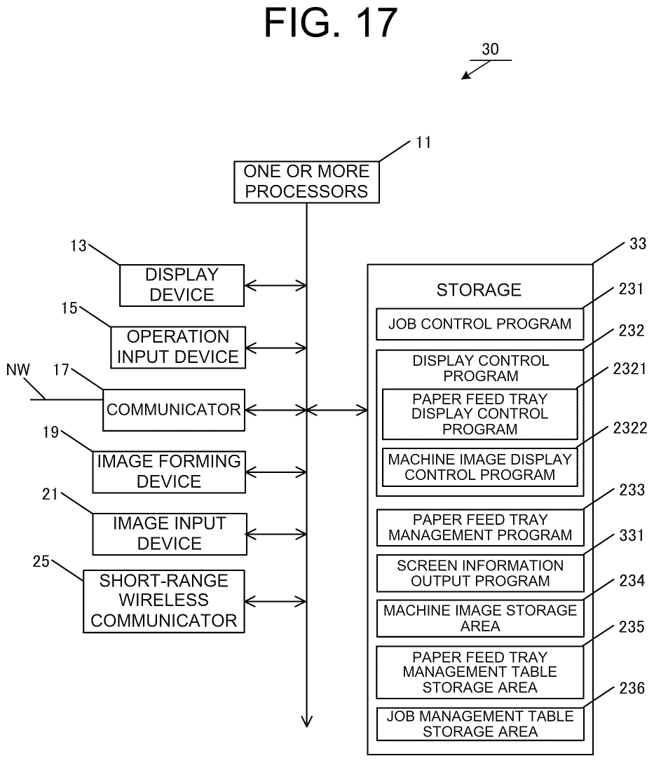

FIG. 17 is a functional configuration diagram of the multifunction peripheral 30. Components of the multifunction peripheral 30 having the same configuration as those of the multifunction peripheral 10 according to the first embodiment will be denoted by the same reference numerals, and the description thereon will not be made.

A short-range wireless communicator 25 includes an interface that is required to communicate with the external terminal apparatus 50 via the short-range wireless communication protocol such as Wi-Fi®, Bluetooth®, the infrared rays, NFC, or RFID.

A storage 33 stores the job control program 231, the display control program 232, the paper feed tray management program 233, and a screen information output program 331, and secures the machine image storage area 234, the paper feed tray management table storage area 235, and the job management table storage area 236.

The screen information output program 331 is a program that is read by the one or more processors 11 when the screen information on the system information screen, which includes the tray information area generated by the display control program 232, is output to the external terminal apparatus 50. The one or more processors 11 that have read the screen information output program 331 output the screen information on the basis of an output instruction that is accepted via the external terminal apparatus 50 or the operation input device 15. The screen information output program 331 can be configured as a web application that can provide the screen information via a web browser or the like, or can be configured as a native application that directly outputs the screen information to the external terminal apparatus 50.

The external terminal apparatus 50 can be configured as a so-called mobile terminal apparatus, such as a smartphone, a tablet, a mobile phone, or a laptop computer, that is generally distributed in the market and has a function to displaying a (graphical) user interface on a screen, a function for communication, and a function unique to the terminal apparatus. Thus, the description on the functional configuration of the external terminal apparatus 50 will not be made.

### 3.2 Processing Flow

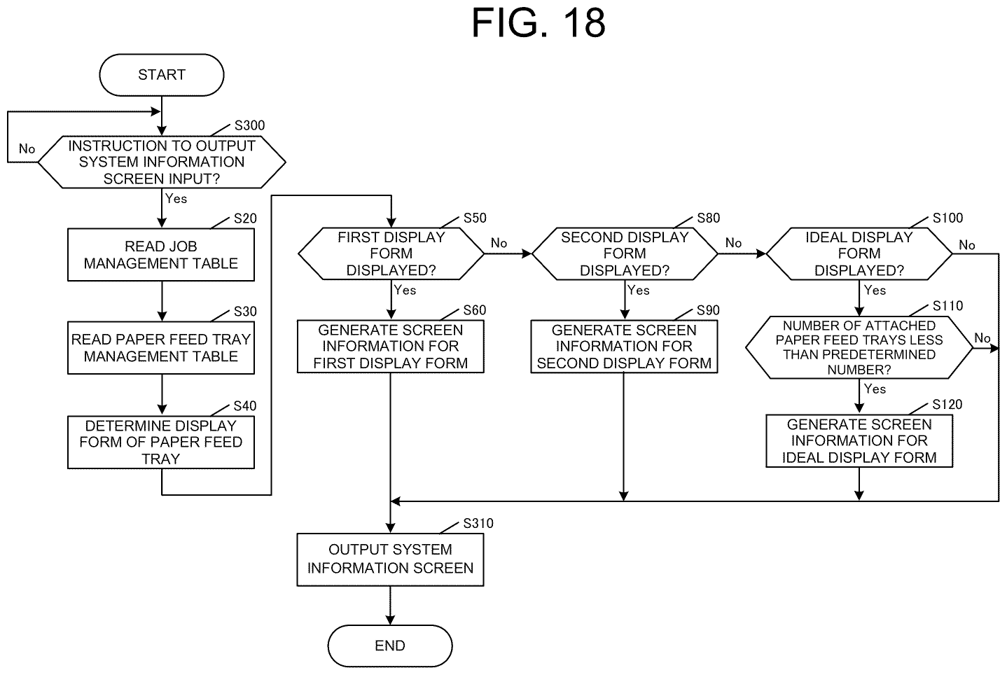

FIG. 18 is a flowchart illustrating a processing flow in the multifunction peripheral 30. In the flowchart illustrated in FIG. 18, step S10 and step S70 in FIG. 3 are replaced with step S300 and step S310, respectively. In step S300, the one or more processors 11 determine whether the instruction to output the system information screen has been input via the external terminal apparatus 50 or the operation input device 15. Then, in step S310, the one or more processors 11 output the screen information on the system information screen. For example, if the instruction to output the system information screen has been input via the external terminal apparatus 50, the one or more processors 11 output the screen information on the system information screen to the external terminal apparatus 50. Then, the external terminal apparatus 50 displays the system information screen on the basis of the acquired screen information.

### 3.3 Operation Example

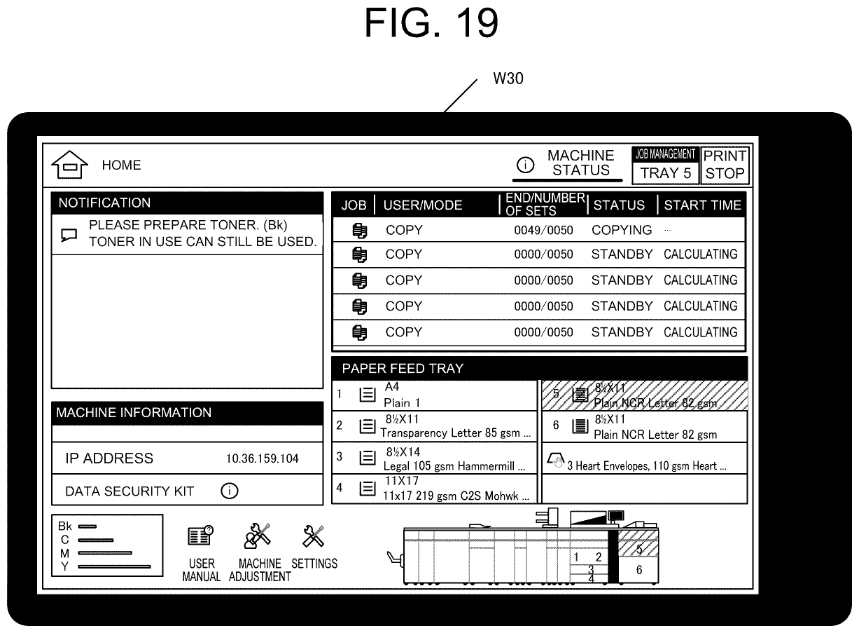

FIG. 19 is a view illustrating a configuration example of a system information screen W30 displayed by the external terminal apparatus 50 that has acquired the screen information on the system information screen output from the multifunction peripheral 30. Based on the screen information received from the multifunction peripheral 30, the external terminal apparatus 50 can display the system information screen W30 that has the same configuration as the system information screen W20A exemplified in FIG. 7.

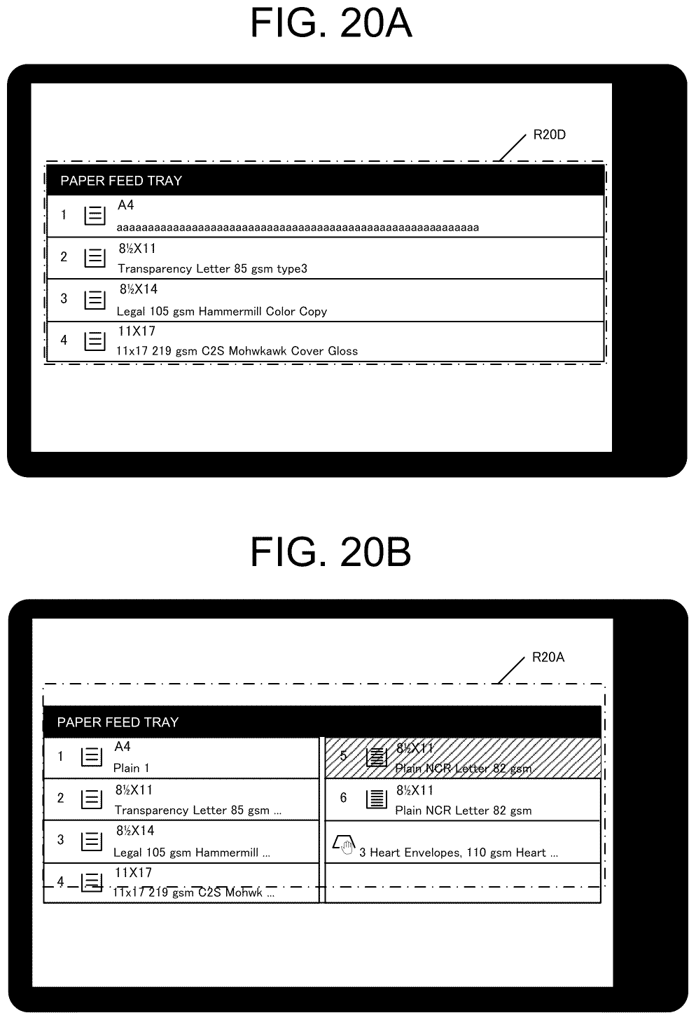

It is also possible to adopt such a mode that, in consideration of a displayable area of a display device provided in the external terminal apparatus 50, the screen information corresponding to the tray information area R20D (corresponding to the second display form: FIG. 20A) and the screen information corresponding to the tray information area R20A (corresponding to the first display form: FIG. 20B) are independently displayed.

As it has been described so far, according to the third embodiment, since the system information screen, which includes the tray information area, can be displayed on the external terminal apparatus 50, the user can grasp the sheet replenishment timing and maintenance timing without directly checking the system information screen that is displayed on the display device 13 of the multifunction peripheral 30.

### 4 Other Display Forms

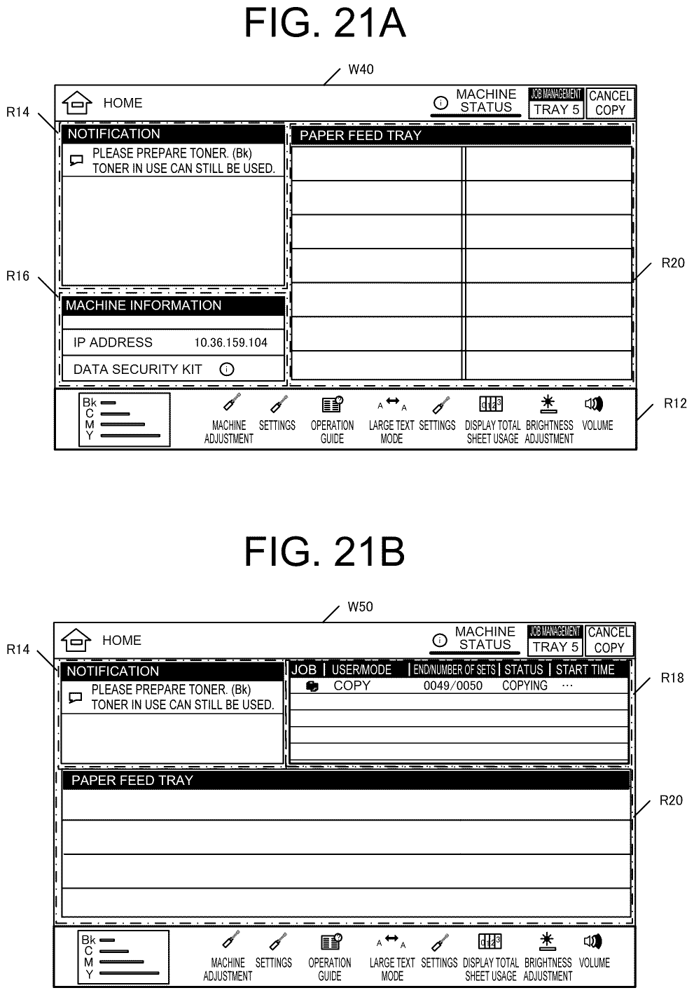

In the first to third embodiments, the description has been made that the display area for each of the notification area R14, the machine information area R16, the job queue area R18, the tray information area R20, and the fixed display area R12 constituting the system information screen W20 is fixed. However, these display areas can appropriately be changed by omitting the display areas other than that for the tray information area R20 according to the amount of the displayed information, a degree of importance of the displayed information, a degree of urgency, or the like. For example, FIG. 21A illustrates an example in which the display area for the job queue area R18 is omitted and the display area for the tray information area R20 in the first display form is expanded in a vertical direction in the drawing. FIG. 21B illustrates an example in which the display area for the machine information area R16 is omitted and the display area for the tray information area R20 in the second display form is expanded in a lateral direction in the drawing. Just as described, for example, in the case where there is no registered job in the job queue, in the case where there is a little or no information provided as the machine information, or the like, the display area for displaying these pieces of the information is omitted. In this way, it is possible to secure the display area for the tray information area R20.

In the present disclosure, the description has been made on the form for displaying the machine image, which simulates the external appearance of the machine, on the system information screen. In addition to the system information screen, the machine image can also be displayed on another display screen, such as the home screen for accepting selection of a job execution mode or the like, or the unillustrated setting screen for accepting the input of the various setting values related to the job execution, that can be displayed by the image forming apparatus.

The present disclosure is not limited to the embodiments described above, and various modifications may be made thereto. That is, the technical scope of the present disclosure also includes embodiments that may be obtained by combining technical measures that are modified as appropriate without departing from the gist of the present disclosure.

In addition, the above-described embodiments have parts that are described separately for convenience of the description. However, it is needless to say that the embodiments may be combined and implemented within the technically possible range.

The program that operates in each of the devices in the embodiments is a program that controls the CPU or the like (a program that causes a computer to function) in a manner to implement the functions in the above-described embodiments. The information that is handled in these devices is temporarily accumulated in a temporary storage device (for example, the RAM) during processing, is then stored in various storage devices such as the ROM and the HDD, and is read, corrected, or written by the CPU when necessary.

Here, the recording medium that stores the program may be any one of a semiconductor medium (for example, the ROM, a non-volatile memory card, or the like), an optical recording medium or a magnetooptical recording medium (for example, a digital versatile disc (DVD), a magnetooptical disc (MO), a mini disc (MD), a compact disc (CD), a Blu-ray® disc (BD), or the like), and a magnetic recording medium (for example, a magnetic tape, a flexible disk, or the like). In addition, the functions in the above-described embodiments may be implemented by executing the loaded program. In some cases, the functions in the present disclosure are implemented by processing in collaboration with an operating system or another application program on the basis of instructions of the program.

Furthermore, in the case of the market distribution, the program can be stored and distributed in a portable recording medium, or transferred to a server computer that is connected via a network such as the Internet. In this case, a storage device of the server computer is also included in the present disclosure as a matter of course.

The functional blocks or the various features of the devices used in the above-described embodiments can be implemented or executed by an electrical circuit, such as an integrated circuit or plural integrated circuits. The electrical circuit that is designed to implement the functions described in the present specification may include a general-purpose processor, a digital signal processors (DSP), an application-specific integrated circuit (ASIC), a field programmable gate array (FPGA), another programmable logic device, a discrete gate or transistor logic, a discrete hardware component, or a combination of these. The general-purpose processor may be a microprocessor or may be a conventional processor, controller, microcontroller, or state machine. The above-described electrical circuit may be configured as a digital circuit or may be configured as an analog circuit. When an integrated circuit technology that replaces the current integrated circuit emerges as a result of advances in semiconductor technology, one or more aspects of the present disclosure may also use a new integrated circuit based on such technology.

What is claimed is:

1. An image forming apparatus comprising:
a display device that displays tray information on a paper feed tray attached to the apparatus; and
one or more processors that control display on the display device, wherein
the tray information includes medium information on a stored recording medium, and
the one or more processors
accept a switching instruction from a user and
switch a display form to one of a first display form, in which the tray information is displayed in a list, and a second display form, in which the medium information is displayed with a different information amount from that in the first display form.

2. The image forming apparatus according to claim 1, wherein
the one or more processors display the medium information displayed in the second display form with a larger information amount than the medium information displayed in the first display form.

3. The image forming apparatus according to claim 1, wherein
in regard to the medium information that cannot be displayed in a display area for each of the paper feed trays in the first display form, the one or more processors express presence of the medium information, display of which is omitted, by displaying an elision symbol.

4. The image forming apparatus according to claim 1, wherein
the one or more processors display, via a tooltip, the medium information that cannot be displayed in a display area for each of the paper feed trays in the first display form.

5. The image forming apparatus according to claim 1, wherein
in regard to the tray information that cannot be displayed on a screen in the second display form, the one or more processors express presence of the tray information, display of which is omitted, by displaying a widget for accepting a screen moving operation.

6. The image forming apparatus according to claim 1, wherein
in the first display form, in the case where number of pieces of the tray information to be displayed is less than a predetermined display number, the one or more processors expand a display area to increase an information amount of the displayed medium information.

7. The image forming apparatus according to claim 1, wherein
the one or more processors determine a display order of the tray information based on a use frequency of each of the paper feed trays.

8. The image forming apparatus according to claim 1, wherein
the one or more processors determine a display mode of the tray information based on an attached state of the paper feed tray to the apparatus.

9. The image forming apparatus according to claim 1, wherein
the one or more processors display the tray information on the paper feed tray, which is currently used in an executed job, and the tray information on the paper feed tray, which is scheduled to be used in a next job, in a different display mode from a display mode of the tray information on the paper feed tray not involved in use in a job.

10. The image forming apparatus according to claim 1 further comprising:
a communicator that communicates with an external terminal apparatus, wherein
the one or more processors output screen information via the communicator, the screen information being used to reproduce display of the tray information on a display device provided in the external terminal apparatus.

11. A display control method for controlling display of tray information on a paper feed tray that is attached to an apparatus,
the tray information including medium information on a stored recording medium, the display control method comprising:
accepting a switching instruction from a user; and
switching a display form to one of a first display form, in which the tray information is displayed in a list, and a second display form, in which the medium information is displayed with a different information amount from that in the first display form.
